(19) United States
(12) Patent Application Publication
(10) Pub. No.: US 2009/0100493 A1
(43) Pub. Date: Apr. 16, 2009

(54) System and Method for Display Format Detection at Set Top Box Device

(75) Inventors: Todd W. Jones, Kansas City, MO (US); Brian Wilson, Liberty, MO (US); James Huffman, Kansas City, MO (US)

Correspondence Address: AT&T Legal Department - LNAP;Attn: Patent Docketing, Room 2A- 207, One AT & T Way, Bedminster, NJ, 07921, US

(73) Assignee: AT&T Knowledge Ventures, LP., Reno, NV (US)

(21) Appl. No.: 11/873,260

(22) Filed: Oct. 16, 2007

(51) Int. Cl. H04N 7/173

(52) U.S. Cl. 725/131

(57) ABSTRACT

A set top box (STB) device receives a data stream comprising video content data and meta data. The data stream can include, for example, an H.264-compliant data stream transmitted to the STB device via a packet-switched network, such as an Internet Protocol Television (IPTV) network. The meta data comprises an indicator of a display format for the video content data. The STB device accesses the indicator from the data stream and processes the video content data to generate a first display data having the first display format. The STB device can include a preset static display format configuration that is overridden by the STB device in response to accessing the indicator.

### FIELD OF THE DISCLOSURE

The present disclosure generally relates to the provision of video content, and more particularly relates to formatting video content for display.

### BACKGROUND

Televisions often are configured to reformat video content to meet their particular display characteristics. To illustrate, a High Definition (HD) television configured for a display resolution of 1280×720 (HD 720) typically will up-convert video content having a lower resolution before it is displayed. Conversely, a television configured for the National Televisions Standard Committee (NTSC) resolution of 720×480 typically will down-convert video content having a higher resolution before it is displayed. Similarly, a television configured for progressive scan display may deinterlace video content having an interlaced scan format before it is displayed.

With the prevalence of cable television providers and satellite television providers, many viewer premises incorporate set top box (STB) devices such as cable receivers or satellite receivers to interface between the service provider's network and the viewer's television. However, while the television to which a STB device is connected may be capable of supporting any of a variety of display formats, conventional STB devices are statically preconfigured to a particular display format, such as 720p (1280×720 progressive scan) or 1080i (1920×1080 interlace scan), regardless of the capabilities of the television. Accordingly, when a conventional STB device receives video content that has a native display format that differs from the preset display format of the STB device, the STB device automatically converts the video content into the preset display format before providing the video content to the television for display. However, as the producer of the video content presumably selected the native format of the video content for aesthetic or practical considerations, the preset display format may not be the most appropriate display format for the television. Moreover, the display format conversion to the preset display format at the STB device can introduce aliasing issues in the converted video content because non-video information such as closed captioning information, can appear as raster lines above cropped video as a result of conversion of lower-definition video content into higher-definition video content.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a diagram illustrating an example multimedia content distribution system in accordance with at least one embodiment of the present disclosure;

FIG. 2 is a flow diagram illustrating an example method for distributing video content from a service provider to a display device via a set top box (STB) device in accordance with at least one embodiment of the present disclosure;

FIG. 3 is diagram illustrating an example operation of the multimedia content distribution system of FIG. 1 in accordance with at least one embodiment of the present disclosure;

FIG. 4 is a diagram illustrating another example operation of the multimedia content distribution system of FIG. 1 in accordance with at least one embodiment of the present disclosure;

FIG. 5 is a block diagram illustrating an example Internet Protocol Television (IPTV) network in which the multimedia content distribution system of FIG. 1 can be implemented in accordance with at least one embodiment of the present disclosure; and

FIG. 6 is a diagram illustrating an example computer system for implementing one or more of the techniques described herein in accordance with at least one embodiment of the present disclosure.

The use of the same reference symbols in different drawings indicates similar or identical items.

### DETAILED DESCRIPTION OF THE DRAWINGS

The numerous innovative teachings of the present application will be described with particular reference to the presently preferred example embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

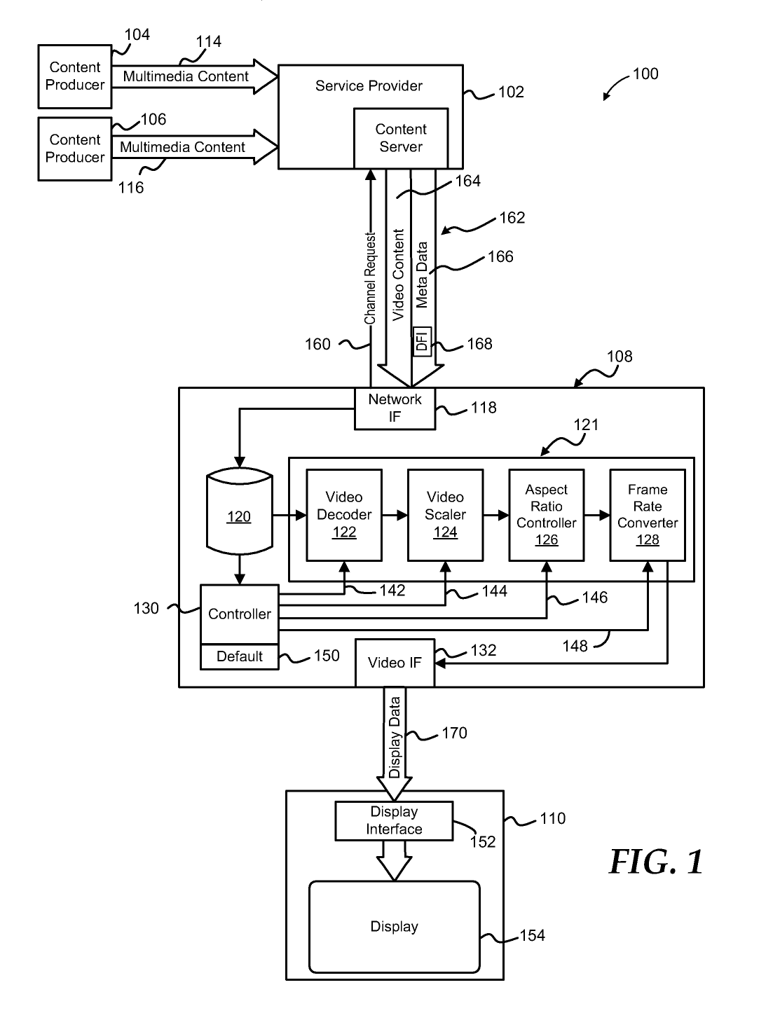

FIGS. 1-6 illustrate example techniques for processing video content at a set top box (STB) device so that it is provided to a display device in the native display format intended for the video content. In at least one embodiment, the STB device receives a data stream comprising video content data associated with, for example, a program or channel selected by a viewer. The data stream further includes meta data having a display format indicator (e.g., an Active Format Descriptor (AFD)) of an intended display format for the corresponding video content data. The STB device buffers the data stream and accesses the display format indicator to determine the intended display format. The STB device then can configure its video processing components to process the video content data so as to generate display data having the intended display format, regardless of a preset static display format set for the STB device. The resulting display data is provided to a display device (e.g., a television or monitor). The display device either can present the video content represented by the display data in the intended display format or the display device can convert the display data into a different display format before presentation as appropriate for the particular display characteristics of the display device. By processing video content at the STB device such that it is provided to a display device in its native display format rather than a potentially-inconsistent static display format allows the display device to adapt to different display formats without requiring the viewer to actively reconfigure the STB device each time video content having a different display format is processed for display.

The term “display format,” as used herein, refers to at least a display resolution, a scan format, or a combination thereof. To illustrate, a display format of 720p identifies a display resolution of 1280×720 and a progressive scan format, whereas a display format of 1080i identifies a display resolution of 1920×1080 and an interlaced scan format. Accordingly, the conversion of video content from one display format to a different display format includes at least one of up-conversion of the display resolution, down-conversion of the display resolution, deinterlacing of an interlaced scan format to a progressive scan format, interlacing of a progressive scan format to an interlaced scan format. In addition to a particular display resolution or a particular scan format, a display format also can include other display characteristics, such as a particular frame rate, a particular aspect ratio (e.g., 16:9 and 4:3), and the like.

A display format indicator can include a single value or other identifier representative of more than one characteristic of a display format. To illustrate, a display format indicator can include a single value representing the display format “HD1080i,” thereby identifying a display format with a resolution of 1920×1080 and an interlace scan format. Alternately, a display format indicator can include a set of values, each value associated with a corresponding characteristic of the identified display format. To illustrate, a display format indicator can include a first value representing with a display width of 1920 pixels, a second value representing a display height of 1080 pixels, a third value representing a progressive scan format, a fourth value representing a frame rate of 59.97 frames per second (fps), etc.

For ease of illustration, the example techniques disclosed herein are described in the context of a packet-switched network for the delivery of multimedia content encoded in accordance with, for example, the H.264 encoding standard (also known as the Motion Pictures Experts Group (MPEG) 4 Advanced Video Coding (AVC) standard), whereby a STB device is utilized to interface between a display device, such as a television or computer, and the multimedia distribution network of a service provider. However, these techniques also can be implemented in other contexts without departing from the scope of the present disclosure.

FIG. 1 illustrates a multimedia content distribution system 100 for providing multimedia channels to viewer premises for presentation in accordance with at least one embodiment of the present disclosure. In the depicted example, the multimedia content distribution system 100 includes a content distribution network of a service provider 102, such as a cable television provider or satellite television provider, and one or more content producers 104 and 106 (such as a network television producer or a cable television producer). At a viewer's premises are a set top box (STB) device 108 and a display device 110, whereby the STB device 108 interfaces with the service provider 102 for the provision of multimedia content to the display device 110.

The service provider 102 includes a content server 112 configured to receive and store multimedia content from content producers, such as multimedia content 114 and 116 from content producers 104 and 106, respectively. The multimedia content can include video content, audio content, or a combination thereof. The content server 112 then can provide at least a portion of the multimedia content to a viewer's premises as a multimedia channel represented as a data stream, whereby the data stream can include video content data, audio content data, meta data, or a combination thereof.

In at least one embodiment, the video content data of a data stream comprises encoded video data and the audio content data comprises encoded video data, such as multimedia data encoded in compliance with the H.264 standard. The meta data of the data stream can include, for example, electronic programming guide (EPG) information, closed captioning information, and the like. Further, in at least one embodiment, the meta data includes a display format indicator for at least a portion of the video content data of the data stream, whereby the display format indicator identifies a native or intended display format for the corresponding video content data. To illustrate, the display format indicator can be included in the meta data corresponding to the ancillary data, such as the vertical ancillary (VANC) data located in the vertical blanking region. A single display format indicator can be provided for an entire program (e.g., as a field in a meta data packet at the start of the program). Alternately, in the event that the display format changes as a program progresses, multiple different display format indicators can be provided for a program. In at least one embodiment, the display format indicator can comprise an Active Format Descriptor (AFD) value in accordance with the Advanced Television Standards Committee (ATSC) Digital Television (DTV) standard and the H.264 encoding standard.

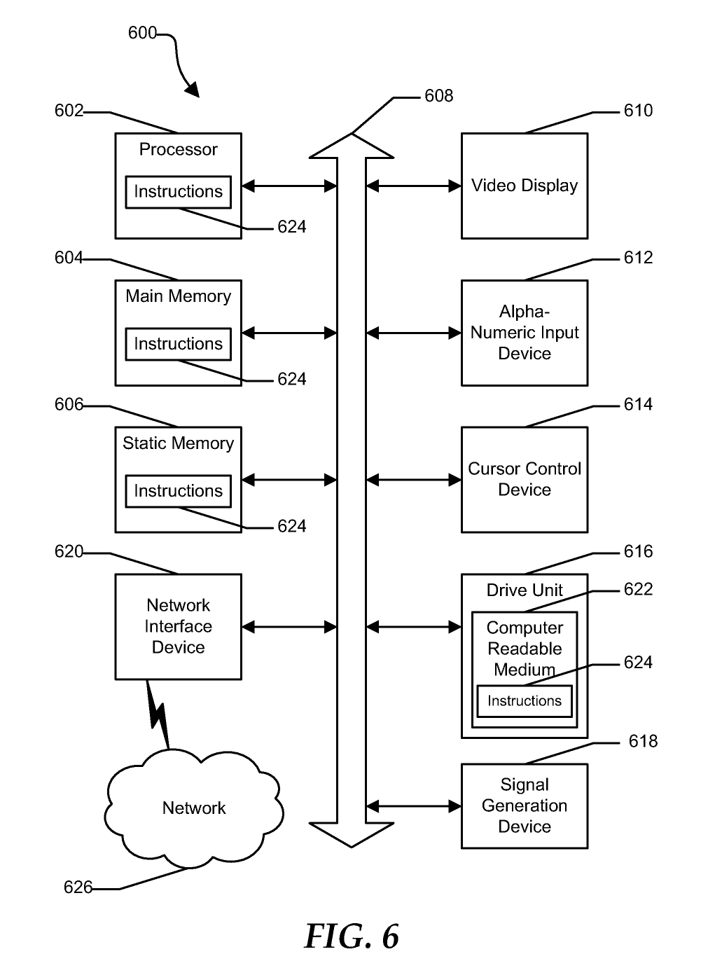

The STB device 108 includes a network interface 118, a buffer 120, and a video processing component 121 (e.g., a video processor). The video processing component 121 includes a video decoder 122, a video scaler 124, an aspect ratio controller 126, and a frame rate converter 128. The STB device 108 also includes a controller 130 and a video interface 132. The STB device 108 further can include a central processing unit (CPU) or other processor (not shown), and one or more computer readable mediums (not shown), such as a memory or a hard drive. As described in greater detail below with reference to FIG. 6, a computer readable medium can store a computer program representing instructions executable by a CPU or other component of the STB device 108 that manipulates the CPU or other component to perform the functions described herein.

The network interface 118 is configured to interface with a network for communications with the service provider 102 and therefore includes an interface compatible with the network type of the service provider 102, such as an Ethernet interface, a digital subscriber line (DSL) modem, a fiber optic interface, and the like. The video interface 132 is configured to interface with, and control the operation of, the display device 110 and therefore includes an interface suitable to the connection capabilities of the display device 110, such as a high-definition multimedia interface (HDMI), a digital video interface (DVI), coaxial cable interface based on the NTSC, PAL, or Sequential Color with Memory (SECAM) standards, an S-video interface, a component video interface, audio outputs, and the like.

The video decoder 122, in one embodiment, is configured to decode encoded video content data received via the network interface 118 and buffered in the buffer 120. To illustrate, if the video content data is encoded in accordance with the H.264 standard, the video decoder 410 can include an H.264-compliant video decoder. In this implementation, the video decoding process can include, for example, bit stream decoding (e.g., Huffman decoding), inverse quantization of the decoded bit stream, application of an inverse discrete cosine transform (IDCT) process, image reconstruction via motion compensation, etc. The resulting decoded display data (i.e., decoded video content data) is provided to the video scaler 124, whereupon the video scaler 124 can up-scale the decoded display data to a higher resolution, down-scale the decoded display data to a lower resolution, or pass the decoded display data through without scaling.

The aspect ratio controller 126 is configured to reformat the display data output by the video scaler 124 to an indicated aspect ratio. This reformatting can be achieved by removing video content at one or more sides of video frames, stretching the video content in either the horizontal or vertical direction by duplication or interpolation of pixel data, by introduction of “black bars” (i.e., “letterboxing” or “pillarboxing”), or a combination thereof.

The frame rate converter 128, in turn, is configured to convert the native frame rate of the decoded display data (as output by, for example, the aspect ratio controller 126) to a desired frame rate. This frame rate conversion can include, for example, a change in the frame rate, a conversion from an interlace scan format to a progressive scan format, conversion from a progressive scan format to an interlace scan format, or a combination thereof. To illustrate, the Phase Alternating Line (PAL) standard provides for a frame rate of 25 frames per second (fps), whereas the National Television Standards Committee (NTSC) standard provides for a frame rate of 30 fps. Accordingly, to convert from a PAL format to a NTSC format, the frame rate converter may add five frames per second to the resulting output display data via frame duplication or frame interpolation. Conversely, to convert from a NTSC format to a PAL format, the frame rate converter may remove five frames per second. Similarly, to convert from an interlaced scan format to a progressive scan format, the frame rate converter 128 can combine the odd line field of a frame and the even line field of the frame as a single frame (and drop or duplicate certain frames if frame rate conversion is also needed). Conversely, to convert from a progressive scan format to an interlaced format, the frame rate converter 128 can separate a single frame in it corresponding odd line field and even line field (and drop or duplicate certain fields if frame rate conversion is also needed). After formatting and conversion as appropriate, the resulting display data is provided to the video interface 132 for transmission to the display device 110.

Although FIG. 1 illustrates a particular example sequence for the processing of the decoded video data, different sequences can be implemented without departing from the scope of the present disclosure. For example, the aspect ratio of the decoded display data can be adjusted prior to scaling, rather than after scaling. As another example, frame rate conversion instead may take place after scaling but prior to aspect ratio conversion.

In at least one embodiment, the controller 130 configures the settings of one or more of the video decoder 122, the video scaler 124, the aspect ratio controller 126, and the frame rate converter 128 via control signals 142, 144, 146, and 148, respectively (referred to herein collectively as “control signals 142-148”). Further, in at least one embodiment, the controller 130 is configured to access a display format indicator for the data stream from the buffer 120 and configure the video processing component 121 so as to maintain the display format identified by the accessed display format indicator for the video content of the data stream. This configuration can include, for example, configuring the video scaler 124 to refrain from up-scaling or down-scaling the display data output by the video decoder 122, configuring the aspect ratio controller 126 to refrain from letterboxing or pillar boxing the display data, and configuring the frame rate converter 128 to refrain from converting the display data from an interlace scan rate format to a progressive scan format or vice-versa, a pull-down or pull-up conversion (e.g., a 3:2 pull-down), and the like. As described below with reference to FIG. 6, the controller 130 can be implemented as hardware logic configured to implement the described functions, as a set of instructions configured to manipulate a CPU or other processor to implement the described functions, or a combination thereof.

As with conventional STB devices, the STB device 108 can include a preset static display format configuration (represented as, for example a value stored in a default configuration register 150 or other storage component) which can be used by the controller 130 to control video processing component 121 so as to achieve the preset, or default, display format. This default display format typically is programmed by a viewer when the STB device 108 is configured by the viewer for use with a particular display device. In instances where a default display format is implemented by the STB device 108, the controller 130 is configured to override the default display format and instead implement the display format identified from the display format indicator accessed from the meta data of the data stream. In one embodiment, each of the video decoder 122, the video scaler 124, the aspect ratio controller 126, and the frame rate converter 128 is configured based on access to the default configuration register 150. In this instance, the controller 130 can override the preset display format by configuring some or all of the control signals 142-148 to signal an override condition.

The display device 110 includes a display interface 152 and a display 154. The display interface 152 is configured to receive the display data from the STB device 108 via the video interface 132 and process the display data for presentation on the display 154. As discussed above, the STB device 108 can be configured to provide display data in its native display format or other indicated display format. In instances where the display device 110 is capable of presenting the display data in its received display format, the display interface 152 can provide the content of the display data to the display 154 in the display format in which it was received. Otherwise, if the display format of the received display data exceeds or is otherwise incompatible with the configuration of the display device 110, an error may occur in the presentation of the display data at the display device 110. In some instances, the display interface 152 may be configured to convert the display format of the display data to a supported display format before provision to the display 154.

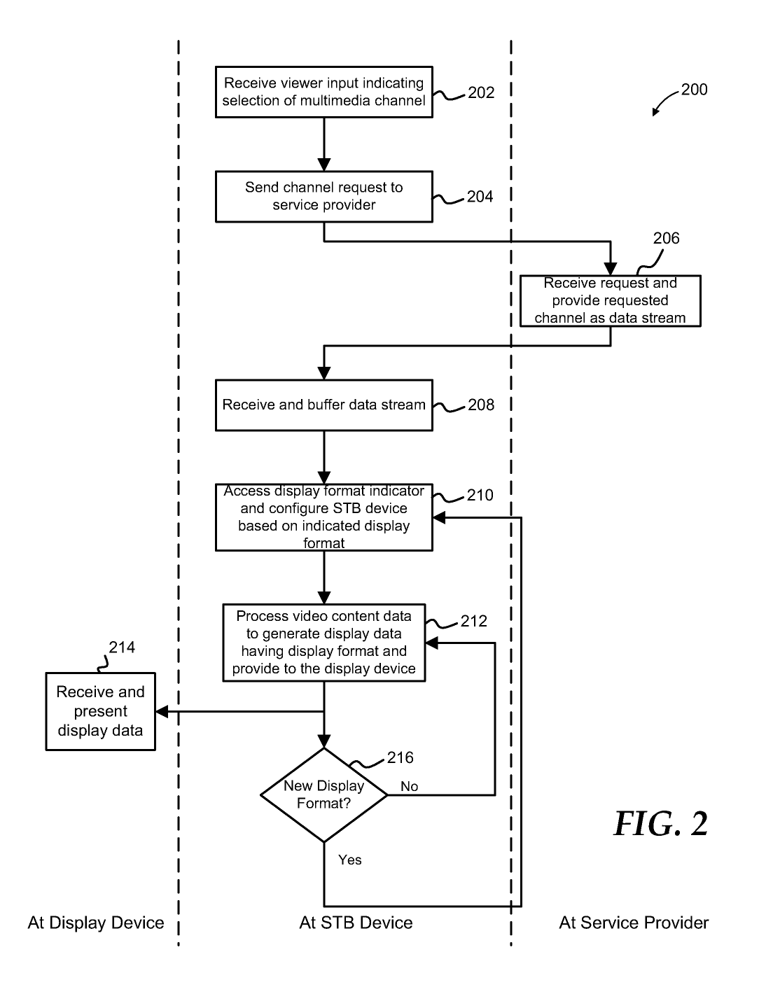

FIG. 2 illustrates a method 200 of an example operation of the multimedia content distribution system 100 of FIG. 1 in accordance with at least one embodiment of the present disclosure. At block 202, the STB device 108 receives viewer input (via, e.g., a remote control or a button panel) indicating that the viewer has selected a particular multimedia channel for viewing. Accordingly, at block 204 the STB device 108 sends a channel request 160 (FIG. 1) to the service provider 102 for the multimedia channel identified by the viewer. At block 206, the content server 112 of the service provider 102 receives the channel request 160, identifies the multimedia content data associated with the requested channel, and provides the identified multimedia content data as a data stream 162 (FIG. 1). The data stream 162 includes video content data 164 (FIG. 1) representing the video content of the multimedia channel and meta data 166 (FIG. 1) associated with the video content data 164. The data stream 162 further can include audio content data (not shown). The video content data 164 can include, for example, video content data encoded in accordance with the H.264 standard. The meta data 166 includes at least one display format indicator 168 (FIG. 1), such as one or more AFD values. The data stream 162, in one embodiment, comprises a sequence of data packets transmitted over one or more Internet Protocol (IP)-based networks.

At block 208, the STB device 108 begins to receive and buffer the data stream 162. In response to receiving the data stream 162, at block 210 the controller 130 accesses the display format indicator 168 from the buffer 120 to determine the display format intended for the corresponding video content data 164. The controller 130 then configures the video processing component 121 of the STB device 108 via one or more of the control signals 142-148 so that the video processing component 121 processes the video content data 164 to generate display data 170 (FIG. 1) having the display format identified by the display format indicator 168. This configuration can include, for example, setting the video scaler 124 to maintain the display data at its original resolution at its output from the video decoder 122, configuring the aspect ratio controller 126 to refrain from stretching, compressing, letterboxing or pillarboxing the display data, and configuring the frame rate converter 128 to refrain from scan format conversion of the display data, and the like. Further, as discussed above, the configuration of the video processing component 121 to implement the display format identified by the AFD value 168 can include overriding a static display format configuration previously set by the viewer or other entity.

At block 212, the video processing component 121 of the STB device 108 processes the buffered video content data in accordance with its configuration as set by the controller 130 to generate the display data 170 having the display format indicated by the display format indicator 168. The STB device 108 provides the display data 170 to the display device 110 as it is generated. At block 214, the display device 110 receives the display data 170 and provides it for presentation at the display 154. The display device 110 either can present the display data 170 in its received display format or the display device 110 can convert the display format of the display data 170 to be more consistent with the particular capabilities of the display device 110.

At block 216 the controller 130 monitors the data stream 162 as it is received and buffered at the STB device 108 to determine whether another display format indicator has been received in the meta data 166 of the data stream 162. In the event that another display format indicator has been received that identifies a different display format, the method 200 returns to block 210 whereby the controller 130 reconfigures the video processing component 121 based on the new display format. Otherwise, the method 200 returns to block 212 whereby the video processing component 121 continues to process the video content data 164 in accordance with the configuration already in place.

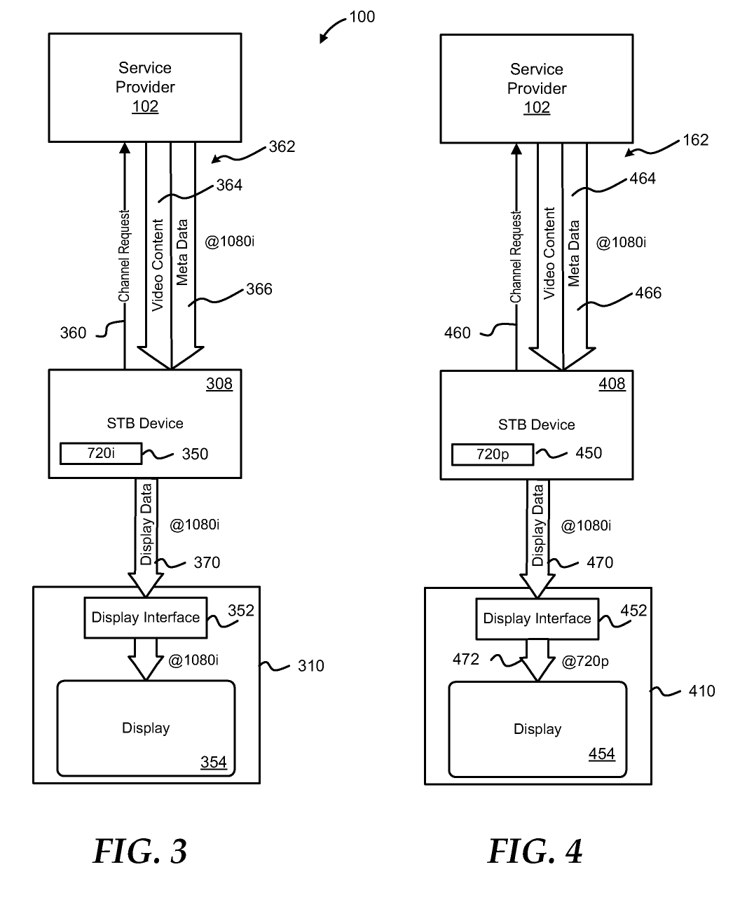

FIGS. 3 and 4 illustrate two examples of the operation of the multimedia content distribution system 100 of FIG. 1. In the example of FIG. 3, a STB device 308 (corresponding to the STB device 108, FIG. 1) receives viewer input indicating a selection of a multimedia channel and, in response, provides a channel request 360 to the service provider 102 for the requested channel. In response, the service provider 102 transmits an H.264-encoded data stream 362 having video content data 364 and meta data 366 to the STB device 308. The meta data 366 includes a display format identifier that identifies a display format of 1080i (1920×1080 interlaced) for the video content data 364. In the illustrated example, the STB device 308 is configured to a default display format of 720i (1280×720 interlaced) via, for example, a default configuration register 350 programmed by the viewer. However, the STB device 308 accesses the display format identifier from the meta data 366, and in response to the display format identified by the display format identifier, overrides the default display format so as to process the video content data 362 to generate display data 370 having the display format of 1080i. In this example, the display device 310 (corresponding to the display device 110, FIG. 1) is capable of displaying video at the 1080i format, and thus the display interface 352 provides the display data 370 to the display 354 for presentation without converting the display format of the display data 370.

In the example of FIG. 4, a STB device 408 (corresponding to the STB device 108, FIG. 1) receives viewer input indicating a selection of a multimedia channel and, in response, provides a channel request 460 to the service provider 102 for the requested channel. In response, the service provider 102 transmits an H.264-encoded data stream 462 having video content data 464 and meta data 466 to the STB device 408. The meta data 466 includes a display format identifier that identifies a display format of 1080i for the video content data 464. For the example of FIG. 4, the STB device 408 is configured to a default display format of 720p (1280×720 progressive scan) via, for example, a default configuration register 450. The STB device 408 accesses the display format identifier from the meta data 466, and in response to the display format identified by the display format identifier, overrides the default display format so as to process the video content data 462 to generate display data 470 having the display format of 1080i. In this example, the display device 410 (corresponding to the display device 110, FIG. 1) is not capable of displaying video at the 1080i format, and instead is capable of a display format of 720p. Accordingly, the display interface 452 of the display device 110 converts the display data 370 from the 1080i display format to the 720p display format to generate display data 472. This conversion can include, for example downscaling the display data 470 from a 1920×1080 resolution to a 1280×720 resolution and by deinterlacing the display data 470 to generate progressively scanned display data. The display interface 452 then provides the display data 472 to the display 454 for presentation.

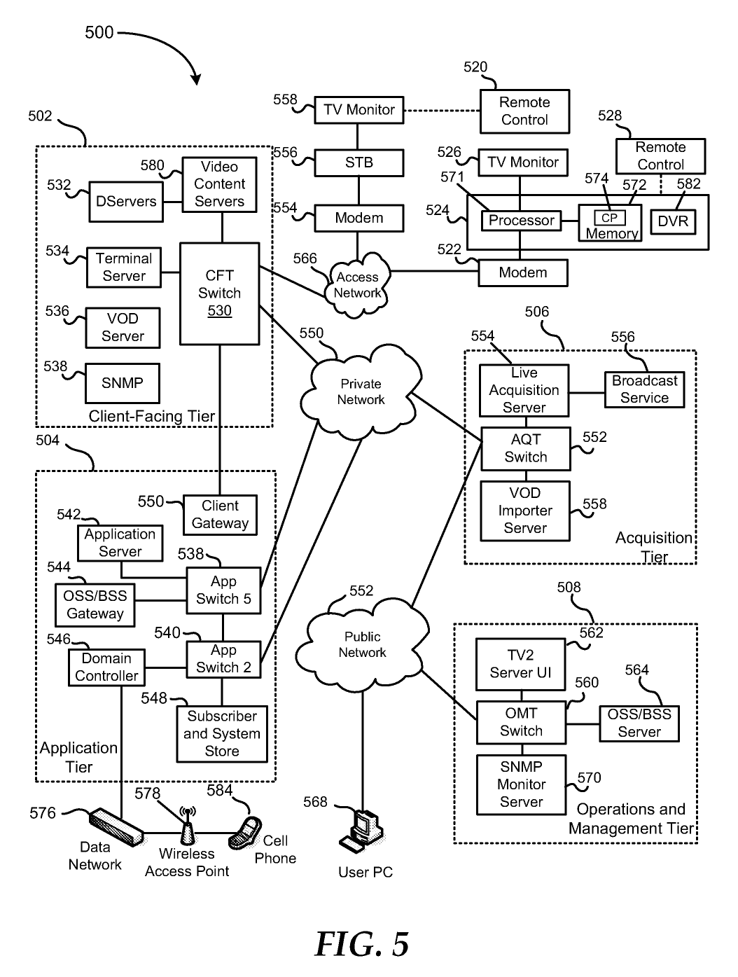

FIG. 5 illustrates an example Internet Protocol Television (IPTV) system 500 in which the disclosed video monitoring techniques can be implemented in accordance with at least one embodiment of the present disclosure. The IPTV system 500 can include a client facing tier 502, an application tier 504, an acquisition tier 506, and an operations and management tier 508. Each tier 502, 504, 506, and 508 is coupled to a private network 510, a public network 512, or both the private network 510 and the public network 512. For example, the client-facing tier 502 can be coupled to the private network 510. Further, the application tier 504 can be coupled to the private network 510 and to the public network 512, such as the Internet. The acquisition tier 506 can also be coupled to the private network 510 and to the public network 512. Moreover, the operations and management tier 508 can be coupled to the public network 512.

The various tiers 502, 504, 506, and 508 communicate with each other via the private network 510 and the public network 512. For instance, the client-facing tier 502 can communicate with the application tier 504 and the acquisition tier 506 via the private network 510. The application tier 504 can also communicate with the acquisition tier 506 via the private network 510. Further, the application tier 504 can communicate with the acquisition tier 506 and the operations and management tier 508 via the public network 512. Moreover, the acquisition tier 506 can communicate with the operations and management tier 508 via the public network 512. In a particular embodiment, elements of the application tier 504 can communicate directly with the client-facing tier 502.

The client-facing tier 502 can communicate with user equipment via a private access network 566, such as an Internet Protocol Television (IPTV) network. In an illustrative embodiment, modems, such as a first modem 514 and a second modem 522 can be coupled to the private access network 566. The client-facing tier 502 can communicate with a first representative STB device 516 via the first modem 514 and with a second representative STB device 524 via the second modem 522. The client-facing tier 502 can communicate with a large number of set-top boxes, such as the representative set-top boxes 516 and 524, over a wide geographic area, such as a regional area, a metropolitan area, a viewing area, or any other suitable geographic area that can be supported by networking the client-facing tier 502 to numerous set-top box devices. In an illustrative embodiment, the client facing tier or any portion thereof can be included at a video head-end office.

In one embodiment, the client-facing tier 502 can be coupled to the modems 514 and 522 via fiber optic cables. Alternatively, the modems 514 and 522 can be digital subscriber line (DSL) modems that are coupled to one or more network nodes via twisted pairs, and the client-facing tier 502 can be coupled to the network nodes via fiber-optic cables. Each set-top box device 516 and 524 can process data received through the private access network 566 via an IPTV software platform such as Microsoft® TV IPTV Edition.

Additionally, the first set-top box device 516 can be coupled to a first display device 518, such as a first television monitor, and the second set-top box device 524 can be coupled to a second display device 526, such as a second television monitor. Moreover, the first set-top box device 516 can communicate with a first remote control 520, and the second set-top box device can communicate with a second remote control 528. In an exemplary, non-limiting embodiment, each set-top box device 516 and 524 can receive data or video from the client-facing tier 502 via the private access network 566 and render or display the data or video at the display devices 518 and 526 to which it is coupled. In an illustrative embodiment, the set-top box devices 516 and 524 can include tuners that receive and decode television programming information for transmission to the display devices 518 and 526. The television tuner can be an NTSC tuner, a SECAM tuner, a PAL tuner, an ATSC tuner, another suitable analog or digital tuner, or any combination thereof. A signal for a television channel can pass through the tuner before the content is displayed on a monitor.

In an exemplary, non-limiting embodiment, STB devices 516 and 524 can receive a data stream including video content data and audio content data from the client-facing tier 502 via the private access network 566. The STB device 516 and 524 can transmit the video content to an external display device, such as the television monitors 518 and 526. The STB devices 516 and 524 can also communicate commands received from the remote control devices 520 and 528 to the client-facing tier 502 via the private access network 566. The STB devices 516 and 524, in one embodiment, implement one or more of the display formatting techniques described above with reference to FIGS. 1-4.

In an illustrative embodiment, the client-facing tier 502 can include a client-facing tier (CFT) switch 530 that manages communication between the client-facing tier 502 and the private access network 566 and between the client-facing tier 502 and the private network 510. As shown, the CFT switch 530 is coupled to one or more data servers 532 that store data transmitted in response to user requests, such as video-on-demand material. The CFT switch 530 can also be coupled to a terminal server 534 that provides terminal devices, such as a game application server 568 and other devices with a common connection point to the private network 510. In a particular embodiment, the CFT switch 530 can also be coupled to a video-on-demand (VOD) server 536 that stores or provides VOD content imported by the IPTV system 500. The client-facing tier 502 can also include one or more channel provision servers 580 that transmit video content requested by viewers via their STB devices 516 and 524. In an illustrative, non-limiting embodiment, the channel provision servers 580 can include one or more multicast servers. The client-facing tier 502 further can include an SNMP monitor server 538 (one embodiment of the channel status servers 138 and 140, FIG. 1) that is configured to process error indicators from the STB devices as described above.

As shown in FIG. 5, the application tier 504 can communicate with both the private network 510 and the public network 512. In this embodiment, the application tier 504 can include a first application tier (APP) switch 538 and a second APP switch 540. In a particular embodiment, the first APP switch 538 can be coupled to the second APP switch 540. The first APP switch 538 can be coupled to an application server 542 and to an OSS/BSS gateway 544. The application server 542 provides applications to the set-top box devices 516 and 524 via the private access network 566, so the set-top box devices 516 and 524 can provide functions, such as display, messaging, processing of IPTV data and VOD material, etc. In a particular embodiment, the OSS/BSS gateway 544 includes operation systems and support (OSS) data, as well as billing systems and support (BSS) data.

Further, the second APP switch 540 can be coupled to a domain controller 546 that provides web access, for example, to users via the public network 512. The second APP switch 540 can be coupled to a subscriber and system store 548 that includes account information, such as account information that is associated with users who access the system 500 via the private network 510 or the public network 512. In a particular embodiment, the application tier 504 can also include a client gateway 550 that communicates data directly to the client-facing tier 502. In this embodiment, the client gateway 550 can be coupled directly to the CFT switch 530. The client gateway 550 can provide user access to the private network 510 and the tiers coupled thereto.

In a particular embodiment, the set-top box devices 516 and 524 can access the system via the private access network 566, using information received from the client gateway 550. The private access network 566 provides security for the private network 510. User devices can access the client gateway 550 via the private access network 566, and the client gateway 550 can allow such devices to access the private network 510 once the devices are authenticated or verified. Similarly, the client gateway 550 can prevent unauthorized devices, such as hacker computers or stolen set-top box devices from accessing the private network 510, by denying access to these devices beyond the private access network 566.

For example, when a set-top box device 516 accesses the system 500 via the private access network 566, the client gateway 550 can verify subscriber information by communicating with the subscriber and system store 548 via the private network 510, the first APP switch 538 and the second APP switch 540. Further, the client gateway 550 can verify billing information and status by communicating with the OSS/BSS gateway 544 via the private network 510 and the first APP switch 538. The OSS/BSS gateway 544 can transmit a query across the first APP switch 538 to the second APP switch 540, and the second APP switch 540 can communicate the query across the public network 512 to an OSS/BSS server 564. After the client gateway 550 confirms subscriber and/or billing information, the client gateway 550 can allow the set-top box device 516 access to IPTV content and VOD content. If the client gateway 550 cannot verify subscriber information for the set-top box device 516, for example because it is connected to a different twisted pair, the client gateway 550 can deny transmissions to and from the set-top box device 516 beyond the private access network 566.

The acquisition tier 506 includes an acquisition tier (AQT) switch 552 that communicates with the private network 510. The AQT switch 552 can also communicate with the operations and management tier 508 via the public network 512. In a particular embodiment during operation of the IPTV system, the live acquisition server 554 can acquire television or movie content. The live acquisition server 554 can transmit the television or movie content to the AQT switch 552, and the AQT switch can transmit the television or movie content to the CFT switch 530 via the private network 510.

Further, the television or movie content can be transmitted to the channel provision servers 580, where it can be encoded, formatted, stored, or otherwise manipulated and prepared for communication to the STB devices 516 and 524. The CFT switch 530 can communicate the television or movie content to the modems 514 and 522 via the private access network 566. The STB devices 516 and 524 can receive the television or movie content via the modems 514 and 522, and can transmit the television or movie content to the television monitors 518 and 526. In an illustrative embodiment, video or audio portions of the television or movie content can be streamed to the STB devices 516 and 524.

Further, the AQT switch can be coupled to a VOD importer server 558 that stores television or movie content received at the acquisition tier 506 and communicates the stored content to the VOD server 536 at the client-facing tier 502 via the private network 510. Additionally, at the acquisition tier 506, the VOD importer server 558 can receive content from one or more VOD sources outside the IPTV system 500, such as movie studios and programmers of non-live content. The VOD importer server 558 can transmit the VOD content to the AQT switch 552, and the AQT switch 552, in turn, can communicate the material to the CFT switch 530 via the private network 510. The VOD content can be stored at one or more servers, such as the VOD server 536.

When users issue requests for VOD content via the STB devices 516 and 524, the requests can be transmitted over the private access network 566 to the VOD server 536 via the CFT switch 530. Upon receiving such requests, the VOD server 536 can retrieve the requested VOD content and transmit the content to the STB devices 516 and 524 across the private access network 566 via the CFT switch 530. The STB devices 516 and 524 can transmit the VOD content to the television monitors 518 and 526. In an illustrative embodiment, video or audio portions of VOD content can be streamed to the STB devices 516 and 524.

The operations and management tier 508 can include an operations and management tier (OMT) switch 560 that conducts communication between the operations and management tier 508 and the public network 512. In the embodiment illustrated by FIG. 5, the OMT switch 560 is coupled to a TV2 server 562. Additionally, the OMT switch 560 can be coupled to the OSS/BSS server 564 and to a simple network management protocol (SNMP) monitor 570 (one embodiment of the channel status server 136 of FIG. 1) that monitors network devices within or coupled to the IPTV system 500. In a particular embodiment, the OMT switch 560 can communicate with the AQT switch 552 via the public network 512.

In a particular embodiment during operation of the IPTV system, the live acquisition server 554 can acquire television content from the broadcast service 556. The live acquisition server 554 can transmit the television or movie content to the AQT switch 552, and the AQT switch 552 in turn can transmit the television content to the CFT switch 530 via the private network 510 or to the OMT switch 560 via the public network 512. Further, the television content can be encoded at the D-servers 532, and the CFT switch 530 can communicate the television content to the modems 514 and, 522 via the private access network 566. The set-top box devices 516 and 524 can receive the television content from the modems 514 and 522, decode the television content, and transmit the content to the display devices 518 and 526 according to commands from the remote control devices 520 and 528.

Additionally, at the acquisition tier 506, the video-on-demand (VOD) importer server 558 can receive content from one or more VOD sources outside the IPTV system 500, such as movie studios and programmers of non-live content. The VOD importer server 558 can transmit the VOD content to the AQT switch 552, and the AQT switch 552 in turn can communicate the material to the CFT switch 530 via the private network 510. The VOD content can be stored at one or more servers, such as the VOD server 536.

When a user issues a request for VOD content to set-top box devices 516 and 524, the request can be transmitted over the private access network 566 to the VOD server 536 via the CFT switch 530. Upon receiving such a request, the VOD server 536 can retrieve requested VOD content and transmit the content to the set-top box devices 516 and 524 across the private access network 566 via the CFT switch 530. In an illustrative embodiment, the live acquisition server 554 can transmit the television content to the AQT switch 552, and the AQT switch 552 in turn can transmit the television content to the OMT switch 560 via the public network 512. In this embodiment, the OMT switch 560 can transmit the television content to the TV2 server 562 for display to users accessing the user interface at the TV2 server. For example, a user can access the TV2 server 562 using a personal computer 568 coupled to the public network 512.

The domain controller 546 communicates with the public network 512 via the second APP switch 540. Additionally, the domain controller 546 can communicate via the public network 512 with the personal computer 568. For example, the domain controller 546 can display a web portal via the public network 512 and allow users to access the web portal using the PC 568. Further, in an illustrative embodiment, the domain controller 546 can communicate with at least one wireless network access point 578 over a data network 576. In this embodiment, each wireless network access device 578 can communicate with user wireless devices, such as a cellular telephone 584.

In a particular embodiment, a set-top box device such as the second set-top box device 524 can include an STB processor 571 and an STB memory device 572 that is accessible to the STB processor 571. The set-top box device 524 also includes a STB computer program 574 that is embedded within the STB memory device 572. In a particular embodiment, the STB computer program 574 can contain instructions to receive and execute at least one user television viewing preference that a user has entered by accessing an Internet user account via the domain controller 546. For example, the user can use the PC 568 to access a web portal maintained by the domain controller 546 via the Internet. The domain controller 546 can query the subscriber and system store 548 via the private network 510 for account information associated with the user. In a particular embodiment, the account information can associate the user's Internet account with the second set-top box device 524. For instance, in an illustrative embodiment, the account information can relate the user's account to the second set-top box device 524, by associating the user account with an IP address of the second set-top box device with data relating to one or more twisted pairs connected with the second set-top box device 524, with data related to one or more fiber optic cables connected with the second set-top box device 524, with an alphanumeric identifier of the second set-top box device 524, with any other data that is suitable for associating second set-top box device 524 with a user account, or with any combination of these.

The STB computer program 574 can contain instructions to receive many types of user preferences from the domain controller 546 via the access network 566. For example, the STB computer program 574 can include instructions to receive a request to record at least one television program at a video content storage module such as a digital video recorder (DVR) 582 within the second set-top box device 524. In this example embodiment, the STB computer program 574 can include instructions to transmit the request to the DVR 582, where the television program(s) are recorded. In an illustrative embodiment, the STB computer program 574 can include instructions to receive from the DVR 582 a recording status with respect to one or more of the television programs and to transmit at least one message regarding the status to a wireless device, such as the cellular telephone 584. The message can be received at the CFT switch 530, for instance, and communicated to the domain controller 546 across the private network 510 via the second APP switch 540. Further, the domain controller 546 can transmit the message to the wireless data network 576, directly or via the public network 512, and on to the wireless network access point 578. The message can then be transmitted to the cellular telephone 584. In an illustrative embodiment, the status can be sent via a wireless access protocol (WAP). Further details of the IPTV system are taught in U.S. Patent Application Publication No. 2007/0199041, the disclosure of which is hereby incorporated by reference.

FIG. 6 shows an illustrative embodiment of a general computer system 600 in accordance with at least one embodiment of the present disclosure. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into, for example, a STB device. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

The computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media. The network interface device 620 can provide connectivity to a network 626, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

What is claimed is:

1. A method comprising:
receiving, at a set top box (STB) device, a data stream comprising video content data and meta data, the meta data comprising a first indicator of a first display format for the video content data;
accessing, at the STB device, the first indicator from the data stream; and
processing, at the STB device in response to accessing the indicator, the video content data to generate a first display data having the first display format.

2. The method of claim 1, further comprising:
providing the first display data from the STB device to a display device.

3. The method of claim 1, wherein the data stream comprises an H.264-compliant data stream.

4. The method of claim 1, wherein:
the first indicator comprises an indicator of a display resolution for the video content data; and
processing the video content data to generate the first display data comprises configuring a video processing component to implement the display resolution for decoding the video content data.

5. The method of claim 1, wherein:
the first indicator comprises an indicator of a frame rate for the video content data; and
processing the first video content data to generate the first display data comprises configuring a video processing component to implement the frame rate.

6. The method of claim 1, wherein:
the first indicator is associated with a first portion of the video content data,
the meta data further comprises a second indicator of a second display format, the second indicator associated with a second portion of the video content data;
the method further comprises accessing, at the STB device, the second indicator from the data stream; and
processing the video content data comprises processing the first portion of the video content data to generate the first display data having the first display format in response to accessing the first indicator and processing the second portion of the video content data to generate a second display data having the second display format in response to accessing the second indicator.

7. The method of claim 6, wherein the first display format comprises a first display resolution and the second display format comprises a second display resolution different than the first display resolution.

8. The method of claim 6, wherein the first display format comprises a first frame rate and the second display format comprises a second frame rate different than the first frame rate.

9. The method of claim 1, wherein processing the video content data comprises overriding a predetermined display format set at the STB device in response to accessing the first indicator.

10. A system comprising:
a set top box (STB) device including:
a first interface to receive a data stream comprising video content data and meta data, the meta data comprising an indicator of a first display format for the video content data;
a second interface coupleable to a display device, the second interface to provide a first display data generated based on the video content data;
a video processing component coupled to the first interface and the second interface; and
a controller to:
access the first indicator; and
configure the video processing component to process the video content data to generate the display data having the first display format in response to accessing the first indicator.

11. The system of claim 10, wherein:
the data stream comprises an encoded data stream;
the display format comprises a display resolution;
the video processor comprises a video decoder and a video scaler, the video decoder to decode the video content data to generate decoded video content data and the video scaler to scale the decoded video content data; and
the controller is to configure the video scaler to maintain a display resolution of the decoded video content data as output by the video decoder.

12. The system of claim 11, wherein the encoded data stream comprises an H.264-compliant data stream.

13. The system of claim 11, wherein:
the display format comprises a scan format;
the video processor comprises a video decoder and a frame rate converter, the video decoder to decode the video content data to generate decoded video content data and the frame rate converter to convert a frame rate of the decoded video content data; and
the controller is to configure the frame rate converter to maintain a frame rate of the decoded video content data as output by the video decoder.

14. The system of claim 10, wherein
the display format comprises a scan format;
the video processor comprises a video decoder and a frame rate converter, the video decoder to decode the video content data to generate decoded video content data and the frame rate converter to convert a frame rate of the decoded video content data; and
the controller is to configure the frame rate converter to maintain a frame rate of the decoded video content data as output by the video decoder.

15. The system of claim 10, wherein:
the meta data further comprises a second indicator of a second display format, the first indicator associated with a first portion of the video content data and the second indicator associated with a second portion of the video content data;
the second interface is to provide the first display data generated based on the first portion of the video content data and to provide a second display data generated based on the second portion of the video content data; and
the controller further is to:
access the second indicator;
configure the video processing component to process the first portion of the video content data to generate the first display data having the first display format in response to accessing the first indicator; and
configure the video processing component to process the second portion of the video content data to generate the second display data having the second display format in response to accessing the second indicator.

16. The system of claim 10, further comprising:
the display device coupled to the second interface of the STB device.

17. The system of claim 10, further comprising:
a storage element configured to store a value representative of a predetermined display format; and
wherein the controller is configured to override implementation of the predetermined display format by the video processing component in response to accessing the first indicator.

18. A set top box (STB) device comprising:
a processor; and
a computer readable medium embodying a set of instructions, the set of instructions including:
instructions to access an indicator from a data stream received at the STB device, the indicator identifying a display format for video content data of the data stream;
instructions to configure, based on the indicator, a video processing component of the STB device to process the video content data to generate display data having the display format; and
instructions to configure the STB device to provide the display data to a display device.

19. The STB device of claim 18, wherein the data stream comprises an H.264-compliant data stream.

20. The STB device of claim 18, wherein the instructions to configure the video processing component comprise instructions to override implementation of a predetermined display format based on the indicator.

21. A method comprising:
receiving, at a set top box (STB) device, a data stream comprising encoded video content data and an Active Format Descriptor (AFD) value representing a display resolution for the encoded video data;
decoding, at the STB device, the encoded video content data based on the AFD value to generate decoded video data having the display resolution; and
providing the decoded video data for display at a display device connected to the STB device.

22. The method of claim 21, wherein decoding the encoded video content data comprises overriding a predetermined display format set at the STB device based on the AFD value.

23. The method of claim 21, wherein the data stream comprises an H.264-compliant data stream.
